(19) United States
(12) Patent Application Publication
(10) Pub. No.: US 2008/0139433 A1
(43) Pub. Date: Jun. 12, 2008

(54) Mixtures And Method For Cleaning Surfaces

(75) Inventors: Christof Mock, Mannheim (DE); Gunnar Schornick, Neuleiningen (DE); Stefan Frenzel, Mannheim (DE); Moritz Ehrenstein, Ludwigshafen (DE); Ernst Jurgen Bauer, Ludwigshafen (DE); Antje Ziemer, Mannheim (DE); Hans-Peter Seelmann-Eggebert, Limburgerhof (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/814,286

(22) PCT Filed: Jan. 23, 2006
(86) PCT No.: PCT/EP2006/050360

§ 371 Date: Jul. 19, 2007

(30) Foreign Application Priority Data
Jan. 24, 2005 (DE) 10 2005 003 308.3
May 19, 2005 (DE) 10 2005 023 801.7
Jun. 24, 2005 (DE) 10 2005 029 745.5
Jul. 22, 2005 (DE) 10 2005 034 977.3

(51) Int. Cl. C11D 17/04

(52) U.S. Cl. 510/158; 510/418; 510/159; 510/404; 510/403

(57) ABSTRACT

Mixtures comprising
(a) pieces of open-cell aminoplastic foam with an average diameter in the range from 50 μm to 5 mm (weight-average),
(b) water,
(c) at least one surfactant and
(d) if appropriate an oil or fat phase.

The present invention relates to mixtures comprising
(a) pieces of open-cell aminoplastic foam with an average diameter in the range from 50 μm to 5 mm (weight-average),
(b) water,
(c) at least one surfactant and
(d) if appropriate an oil or fat phase.
   and a method of producing mixtures according to the invention.

In addition, the present invention relates to a method of cleaning surfaces using mixtures comprising
(a) pieces of open-cell aminoplastic foam with an average diameter in the range from 50 μm to 5 mm (weight-average),
(b) water,
(c) at least one surfactant and
(d) if appropriate an oil or fat phase.

In addition, the present invention relates to the use of mixtures according to the invention as cleaners.

The cleaning of surfaces and cleaners suitable for this purpose are of considerable economic importance. Under consideration in this regard is not only industrial cleaning, but also the manufacture of cleaners which are suitable for the industrial sector and the private sector.

Of particular importance here is washing the body on the one hand, in particular the washing of very dirty parts of the body. Thus, for example, it is difficult to remove residues of lubricating oil completely from hands without damaging the skin in the process. Of specific importance are the surfaces of teeth, which should wherever possible be completely cleaned of deposits (plaque). Also of particular importance are surfaces of objects, which are also referred to for short as surfaces. Surfaces should in many cases ensure a pleasant appearance, a surface spoiled by, for example, stubborn soiling does not, however, appear pleasing. Traces or thin films of soiling should also be completely removed.

On the other hand, it is of great importance to clean shiny surfaces of greasy, oily and, in particular, resinified residues without the surfaces in question becoming damaged, for example appearing dull. In many cases, abrasive substances are used, for example silica gels, or cleaning materials which have an abrasive action, such as sponges, which help with the removal of stubborn residues. The more stubborn the residue, the more strongly abrasive the cleaner used, for example the sponge, or the abrasive in the cleaner, and thus also the greater the risk of harming the surface to be cleaned. Specifically, when cleaning teeth, it must be ensured that the gum does not become damaged, which can happen when using strong abrasives and to

The object was therefore to provide mixtures which are suitable for washing the body and for cleaning surfaces, in particular shiny surfaces, and avoid the disadvantages from the prior art. It was also the object to provide a method of cleaning surfaces which avoids the disadvantages from the prior art.

Accordingly, the mixtures defined at the beginning have been found, comprising
(a) pieces of open-cell aminoplastic foam with an average diameter in the range from 50 μm to 5 mm (weight-average),
(b) water,
(c) at least one surfactant and
(d) if appropriate an oil or fat phase.

In this connection, the components (a) to (d) of the mixtures according to the invention are defined as follows.

Mixtures according to the invention comprise pieces of open-cell aminoplastic foam (a). Such pieces have an average diameter (weight-average) in the range from 50 μm to 5 mm, preferably 75 μm to 3 mm, particularly preferably 100 μm to 2 mm.

Pieces of open-cell aminoplastic foam (a) present in mixtures according to the invention can have a broad or a narrow diameter distribution. Forming the quotient of diameter (mass-average) to diameter (number-average), then the quotient can, for example, be in the range from 1.1 to 10, preferably 1.2 to 3.

Pieces of open-cell aminoplastic foam (a) present in mixtures according to the invention may have a regular or irregular shape. Examples of regular shapes are cubes, cuboids, spheres and ellipsoids. Examples of irregular shapes are granules, shreds and chips.

In one embodiment of the present invention, the pieces of open-cell aminoplastic foam (a) are those based on synthetic organic foam, for example of urea-formaldehyde resins, in particular aminoplastic foams based on aminoplastic-formaldehyde resins, very particularly preferably melamine-formaldehyde resins, with aminoplastic foams based on melamine-formaldehyde resins also being referred to as melamine foams.

In one embodiment of the present invention, the pieces of open-cell aminoplastic foam (a) are aminoplastic foam in which at least 50% of all of the lamellae are open, preferably 60 to 100% and particularly preferably 65 to 99.9%, determined according to DIN ISO 4590.

In one embodiment of the present invention, pieces of open-cell aminoplastic foam (a) are made of hard aminoplastic foam, i.e. for the purposes of the present invention aminoplastic foam which at a compression of 40% have a compressive strength of 1 kPa or more, determined according to DIN 53577.

In one embodiment of the present invention, pieces of open-cell aminoplastic foam (a) were made of aminoplastic foam which has a density in the range from 5 to 500 kg/m³, preferably 6 to 300 kg/m³ and particularly preferably in the range from 7 to 300 kg/m³.

Pieces of open-cell aminoplastic foam (a) present in mixtures according to the invention can have an average pore diameter (number-average) in the range from 1 μm to 1 mm, preferably 50 to 500 μm, determined by analyzing micrographs on sections.

Pieces of open-cell aminoplastic foam (a) present in mixtures according to the invention may, in one embodiment of the present invention, be made of aminoplastic foam which has at most 20, preferably at most 15 and particularly preferably at most 10, pores per m² which have a diameter in the range of up to 20 mm. The other pores usually have a smaller diameter.

In one embodiment of the present invention, pieces of open-cell aminoplastic foam (a) present in mixtures according to the invention have a BET surface area in the range from 0.1 to 50 m²/g, preferably 0.5 to 20 m²/g, determined according to DIN 66131.

In one embodiment of the present invention, pieces of open-cell aminoplastic foam (a) present mixtures according to the invention are made of aminoplastic foam which has a sound absorption degree of more than 50%, measured according to DIN 52215 at a frequency of 2000 Hz and a layer thickness of the foam (a) in question of 50 mm.

In a specific embodiment of the present invention, pieces of open-cell aminoplastic foam (a) present in mixtures according to the invention are made of aminoplastic foam which has a sound absorption degree of more than 0.5, measured according to DIN 52212 at a frequency of 2000 Hz and a layer thickness of the foam (a) in question of 40 mm.

Pieces of open-cell aminoplastic foam (a) present in mixtures according to the invention can be obtained from aminoplastic foam by, for example, comminution. Suitable comminution processes are, in particular, mechanical comminution processes, such as, for example, casting, punching, cutting, chipping, flaking, sawing, grinding, pan grinding, shearing.

Particularly suitable devices for the mechanical comminution of aminoplastic foam are mills, saws, choppers, graters, crushers and grinders.

In one embodiment of the present invention, pieces of open-cell aminoplastic foam (a) are prepared from aminoplastic foam with a density in the range from 5 to 500 kg/m³ and an average pore diameter in the range from 1 μm to 1 mm by mechanical comminution.

Melamine foams which are particularly suitable as starting material for carrying out the process according to the invention are known as such. They are prepared, for example, by foaming
i) a melamine-formaldehyde precondensate which, besides formaldehyde, can comprise further carbonyl compounds, such as, for example, aldehydes, in condensed form, in the presence of
ii) one or more propellants,
iii) if appropriate one or more emulsifiers,
iv) one or more hardeners.

Melamine-formaldehyde precondensates i) may be unmodified, although they may also be modified, for example up to 20 mol % of the melamine can be replaced by other thermoset formers known per se, for example alkyl-substituted melamine, urea, urethane, carboxamides, dicyanodiamide, guanidine, sulfurylamide, sulfonamides, aliphatic amines, phenol and phenol derivatives. As further carbonyl compounds, besides formaldehyde, modified melamine-formaldehyde precondensates can comprise, for example, acetaldehyde, trimethylolacetaldehyde, acrolein, furfurol, glyoxal, phthaldialdehyde and terephthaldialdehyde, in condensed form.

Suitable propellants ii) are: water, inert gases, in particular carbon dioxide, and so-called physical propellants. Physical propellants are compounds which are inert toward the feed components and which are preferably liquid at room temperature and evaporate under the conditions of aminoplastic formation. Preferably, the boiling point of these compounds is below 110° C., in particular below 80° C. Physical propellants also include inert gases which are introduced into the feed components i) and ii) or are dissolved in them, for example carbon dioxide, nitrogen or noble gases.

Suitable compounds liquid at room temperature are chosen from the group comprising alkanes and/or cycloalkanes having at least four carbon atoms, dialkyl ethers, esters, ketones, acetals, fluoroalkanes having 1 to 8 carbon atoms, and tetraalkylsilanes having 1 to 3 carbon atoms in the alkyl chain, in particular tetramethylsilane.

Examples which may be mentioned are: propane, n-butane, iso- and cyclobutane, n-, iso- and cyclopentane, cyclohexane, dimethyl ether, methyl ethyl ether, methyl tert-butyl ether, methyl formate, acetone, and fluorinated alkanes which can be degraded in the troposphere and are therefore harmless for the ozone layer, such as trifluoromethane, difluoromethane, 1,1,1,3,3-pentafluorobutane, 1,1,1,3,3-pentafluoropropane, 1,1,1,2-tetrafluoroethane, 1,1,1-trifluoro-2,2,2-trichloroethane, 1,1,2-trifluoro-1,2,2-trichloroethane, difluoroethanes and heptafluoropropane. The specified physical propellants may be used on their own or in any combinations with one another.

The use of perfluoroalkanes for producing fine cells is known from EP-A 0 351 614.

Emulsifiers iii) which may be used are customary nonionogenic, anionic, cationic or betainic surfactants, in particular C₁₂-C₃₀-alkylsulfonates, preferably C₁₂-C₁₈-alkylsulfonates and polyethoxylated C₁₀-C₂₀-alkyl alcohols, in particular of the formula R¹—O(CH₂—CH₂—O)ₓ—H, where R¹ is chosen from C₁₀-C₂₀-alkyl and x can, for example, be an integer in the range from 5 to 100.

Suitable hardeners iv) are, in particular, acidic compounds, such as, for example, inorganic Brønsted acids, e.g. sulfuric acid or phosphoric acid, organic Brønsted acids, such as, for example, acetic acid or formic acid, Lewis acids and also so-called latent acids.

Examples of suitable melamine foams and processes for their preparation are given in EP-A 0 017 672.

Aminoplastic foam can of course comprise additives and aggregates which are customary in foam chemistry, for example antioxidants, flame retardants, fillers, colorants, such as, for example, pigments or dyes, and biocides, for example

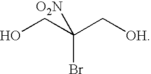

Pieces of aminoplastic foam (a) can have a regular form, for example spherical or ellipsoidal, or essentially an irregular form.

Mixtures according to the invention further comprise water (b), which may be deionized or salt-containing.

Mixtures according to the invention also comprise at least one surfactant (c). Surfactants (c) are chosen from ionic, zwitterionic and preferably nonionic surfactants. Ionic surfactants may be cationic or anionic surfactants.

In one embodiment of the present invention, surfactant (c) is chosen from nontoxic surfactants.

In connection with anionic surfactants, salts are preferably understood as meaning magnesium salts, ammonium salts and alkali metal salts, in particular potassium and sodium salts. Preferred ammonium salts are, for example, triethanolammonium salts and salts of unsubstituted ammonia.

Examples of anionic surfactants are acylamino acids and salts thereof, for example
acyl glutamates, in particular sodium acyl glutamates, where acyl may, for example, be acetyl, butyryl, myristoyl, lauroyl or cocoyl,
sarcosinates, for example myristoylsarcosine, lauroyl sarcosinate triethanolammonium salt, sodium lauroyl sarcosinate and sodium cocoyl sarcosinate.

Further examples of anionic surfactants are sulfonic acids and salts thereof, for example
acyl isethionates, where acyl may, for example, be acetyl, butyryl, myristoyl, lauroyl or cocoyl, for example sodium or ammonium cocoyl isethionate,
sulfosuccinates, for example dioctyl sodium sulfosuccinate, disodium laureth sulfosuccinate, disodium lauryl sulfosuccinate and disodium undecylenamido MEA sulfosuccinate, disodium PEG-5 lauryl citrate sulfosuccinate and derivatives,
   and sulfuric half-esters, such as
alkyl ether sulfate, for example sodium, ammonium, magnesium, monoisopropanolammonium, triisopropanolammonium laureth sulfate, sodium myreth sulfate and sodium C₁₂₋₁₃ parethsulfate,
alkyl sulfates, for example sodium, ammonium and triethanolammonium salts of lauryl sulfate.

Further advantageous anionic surfactants are
taurates, for example sodium lauroyl taurate and sodium methyl cocoyl taurate,
ether carboxylic acids, for example, sodium laureth-13 carboxylate and sodium PEG-6 cocamide carboxylate, sodium PEG-7 olive oil carboxylate,
phosphoric esters and salts, such as, for example, DEA oleth-10 phosphate and dilaureth-4 phosphate,
substituted alkylsulfonates, for example sodium cocomonoglyceridesulfate, sodium C₁₂-C₁₄-α-olefinsulfonate, sodium lauryl sulfoacetate and magnesium PEG-3 cocamide sulfate,
acyl glutamates, such as di-TEA palmitoyl aspartate and sodium caprylic/capric glutamate,
acyl peptides, for example palmitoyl hydrolyzed milk protein, sodium cocoyl hydrolyzed soya protein and sodium/potassium cocoyl hydrolyzed collagen (collagen decomposed by cocoyl peptide).

Within the scope of the present invention, TEA here is the triethanolammonium salt and DEA is the diethanolammonium salt. In addition, within the scope of the present invention, PEG is in each case polyethylene glycol, and the number after it is in each case the average number of ethylene oxide units per molecule.

Further advantageous anionic surfactants are carboxylic acids and derivatives, for example salts or esters,
in particular lauric acid, aluminum stearate, magnesium C₁-C₁₀-alkoxide and zinc undecylenate, ester carboxylic acids, for example calcium stearoyl lactylate, laureth-6 citrate and sodium PEG-4 lauramide ester,
alkylarylsulfonates, for example of the formula R²—Ar—SO₃M′, where R² is preferably an unbranched C₁₀-C₁₃-alkyl, Ar is, for example, phenylene or naphthylene, in particular para-phenylene or 1,5-naphthylene and M¹ is monovalent cations and, in particular, sodium cations.

Preferred cationic surfactants for the purposes of the present invention are quaternary surfactants. Quaternary surfactants comprise at least one N atom which is covalently bonded to 4 identical or different organic nonionic radicals, for example C₁-C₃₀-alkyl or C₆-C₁₄-aryl groups.

Advantageous cationic surfactants for the purposes of the present invention are also
C₁₀-C₃₀-alkylamines,
C₁-C₃₀-alkylimidazoles,
mono- or poly-, in particular mono- to decaethoxylated C₁₀-C₃₀-alkylamines, for example coconut fatty amine,
and in particular salts thereof, in particular halides, such as, for example, chloride and bromide.

Examples of advantageous zwitterionic surfactants are
C₁-C₂₀-acyl-/di-C₁-C₃₀-alkylethylenediamines, for example sodium C₁-C₂₀-acyl amphoacetate, disodium C₁-C₂₀-acyl amphodipropionate, disodium C₁-C₃₀-alkyl amphodiacetate, preferably disodium C₁₀-C₂₅-alkyl amphodiacetate, sodium C₁-C₂₀-acyl amphohydroxypropylsulfonate, disodium C₁-C₂₀-acyl amphodiacetate, sodium C₁-C₂₀-acyl amphopropionate, and N-coconut fatty acid amidoethyl N-hydroxyethylglycinate sodium salts,
N—C₁-C₃₀-alkylamino acids, preferably N—C₁₀-C₂₅-alkylamino acids, for example aminopropyl-C₁-C₃₀-alkylglutamide, preferably aminopropyl-C₁₀-C₂₅-alkylglutamide, N—C₁-C₃₀-alkylaminopropionic acid, preferably N—C₁₀-C₂₅-alkylaminopropionic acid, sodium C₁-C₃₀-alkylimidodipropionate, preferably sodium C₁₀-C₂₅-alkylimidodipropionate and lauroamphocarboxyglycinate.
C₁-C₂₀-alkylbetaine, C₁-C₂₀-alkylamidopropylbetaine and C₁-C₂₀-alkylamido-propylhydroxysultaine.

Examples of advantageous nonionic surfactants are
alkanolamides, for example mono- or di-ω-C₂-C₄-alkanol-C₁-C₃₀-carboxamides, such as cocamide MEA/DEA/MIPA,
esters which are formed by esterification of C₂-C₃₀-carboxylic acids with glycerol, sorbitan or other alcohols or with ethylene oxide,
for example mono- or polyethoxylated C₂-C₃₀-alcohols, in particular 3 to 80-fold ethoxylated C₂-C₃₀-alkanols, ethoxylated lanolin, ethoxylated polysiloxanes, propoxylated POE ethers, alkyl polyglycosides, such as lauryl glucoside, n-decyl glycoside and cocoglycoside, glycosides with a HLB value of at least 20 (e.g. Belsil®SPG 128V (Wacker)).

Further advantageous nonionic surfactants are C₁₂-C₃₀-alkanols and C₁₂-C₃₀-amine oxides, such as cocoamidopropylamine N-oxide.

In one embodiment of the present invention, surfactant (c) present in mixtures according to the invention, or at least one surfactant (c) present in mixtures according to the invention has a HLB value of more than 25, preferably a HLB value of more than 35. HLB value here should be understood as meaning the HLB value according to W. C. Griffin, i.e. understood as meaning 20 times the mass fraction of ethylene oxide (EO), propylene oxide (PO), glycerol or sorbitan in the particular surfactant molecule.

Further suitable surfactants (c) are poly, in particular 3 to 50-fold ethoxylated mono-, di- or trifatty acid esters of sorbitan, so-called polysorbates, for example
polyoxyethylene(20) sorbitan monolaurate (Tween 20, CAS No. 9005-64-5)
polyoxyethylene(4) sorbitan monolaurate (Tween 21, CAS No. 9005-64-5)
polyoxyethylene(4) sorbitan monostearate (Tween 61, CAS No. 9005-67-8)
polyoxyethylene(20) sorbitan tristearate (Tween 65, CAS No. 9005-71-4)
polyoxyethylene(20) sorbitan monooleate (Tween 80, CAS No. 9005-65-6)
polyoxyethylene(5) sorbitan monooleate (Tween 81, CAS No. 9005-65-5)
polyoxyethylene(20) sorbitan trioleate (Tween 85, CAS No. 9005-70-3).

Particularly suitable surfactants (c) are:
polyoxyethylene(20) sorbitan monopalmitate (Tween 40, CAS No. 9005-66-7)
polyoxyethylene(20) sorbitan monostearate (Tween 60, CAS No. 9005-67-8).

In mixtures according to the invention, one or more different surfactants (c) may be present, where, for example, mixtures of alkoxylated fatty alcohols as are usually produced in the synthesis and in which, for example, the individual molecules only differ slightly in the degree of alkoxylation is to be regarded as a surfactant (c) within the scope of the present invention.

Mixtures according to the invention can also comprise an oil or fat phase (d). The oil or fat phase (d) can be formed, for example, by one or more natural or synthetic oil, fats or waxes.

In one embodiment of the present invention, the oil or fat phase (d) is composed of one or preferably more constituents which are listed below.

Constituents of the oil and/or fat phase (d) can be chosen, for example, from the group of lecithins and of fatty acid triglycerides, e.g. the triglycerol esters of saturated and/or unsaturated, branched and/or unbranched alkanecarboxylic acids having a chain length of from 8 to 24, in particular 12 to 18, carbon atoms. Fatty acid triglycerides can, for example, be chosen advantageously from the group of synthetic, semisynthetic and natural oils, such as, for example, olive oil, sunflower oil, soyoil, peanut oil, rapeseed oil, almond oil, palm oil, coconut oil, castor oil, wheat germ oil, grape seed oil, thistle oil, evening primrose oil and macadamia nut oil.

Further constituents of the oil and/or fat phase (d) can be chosen from the group of esters of saturated and/or unsaturated, branched and/or unbranched alkanecarboxylic acids having a chain length of from 3 to 30 carbon atoms and saturated and/or unsaturated, branched and/or unbranched alcohols having a chain length of from 3 to 30 carbon atoms, and from the group of esters of aromatic carboxylic acids and saturated and/or unsaturated, branched and/or unbranched alcohols having a chain length of from 3 to 30 carbon atoms. Preferred examples are isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyidodecyl palmitate, oleyl oleate, oleyl erucate, erucyl oleate, erucyl erucate dicaprylyl carbonate (Cetiol CC) and cocoglycerides (for example Myritol 331), butylene glycol dicaprylate/dicaprate and di-n-butyl adipate, and synthetic, semisynthetic and natural mixtures of such esters, such as, for example, jojoba oil.

Further constituents of the oil or fat phase (d) can be chosen from the group of branched and unbranched hydrocarbons and hydrocarbon waxes, silicone oils, di-C₅-C₂₀-alkyl ethers, the group of saturated or unsaturated, branched or unbranched C₁₂-C₃₀-alcohols, which can also adopt a surfactant function.

Any mixtures of the constituents specified above can also be used as oil or fat phase (d) in mixtures according to the invention.

It may be advantageous to use waxes, for example cetyl palmitate, as the sole lipid component of the oil phase.

Preferred constituents of the oil or fat phase (d) are chosen from the group consisting of 2-ethylhexyl isostearate, octyidodecanol, isotridecyl isononanoate, isoeicosane, 2-ethylhexyl cocoate, C₁₂-C₁₅-alkyl benzoate, caprylic/capric triglyceride, dicaprylyl ether.

Examples of preferred mixtures of constituents of the oil or fat phase (d) are chosen from mixtures of C₁₂-C₁₅-alkyl benzoate and 2-ethylhexyl isostearate, mixtures of C₁₂-C₁₅-alkyl benzoate and isotridecyl isononanoate, and mixtures of C₁₂-C₁₅-alkyl benzoate, 2-ethylhexyl isostearate and/or isotridecyl isononanoate.

According to the invention, as oils with a polarity of from 5 to 50 mN/m, particular preference is given to using fatty acid triglycerides, in particular soya oil and/or almond oil.

From the group of hydrocarbons, it is possible, for example, to use paraffin oil, squalane, squalene and in particular if appropriate hydrated polyisobutenes as oil or fat phase (d).

In one embodiment of the present invention, the oil or fat phase (d) can be chosen from Guerbet alcohols. Guerbet alcohols per se are known and obtainable, for example, by heating two equivalents of alcohol of the general formula R²—CH₂—CH₂—OH in the presence of, for example, Na and/or Cu to give alcohols of the formula R²—CH₂—CH₂—CHR²—CH₂—OH. Here, R² is C₂-C₂₀-alkyl, branched or preferably unbranched, in particular unbranched C₃-C₁₄-alkyl, for example in each case unbranched propyl, butyl, pentyl, hexyl, heptyl, octyl, nonyl, decyl, undecyl, dodecyl, tridecyl or tetradecyl. Guerbet alcohols suitable particularly preferably as oil or fat phase (d) are 2-n-butyloctanol (R²=n-C₄H₉) and 2-n-hexyldecanol (R²=n-C₆H₁₃) and mixtures of the abovementioned Guerbet alcohols.

In one embodiment of the present invention, the oil or fat phase (d) can be chosen from polyolefins, in particular poly-α-olefins. Among the polyolefins, poly-n-decenes are preferred.

In one embodiment of the present invention, the oil or fat phase (d) can consist of cyclic or linear silicone oils or preferably comprise cyclic or linear silicone oils.

Silicone oils are generally silicones which are liquid at room temperature and preferably defined by the following general formula

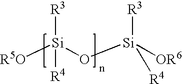

where R³, R⁴, R⁵ and R⁶ may each be identical or different and chosen from C₁-C₁₀-alkyl, in particular methyl, or phenyl. The variable n is integers in the range from 1 to 200. In cyclic silicone compounds, R⁵ and R⁶ together are an (SiR³R⁴) group.

Phenyltrimethicone is advantageously chosen as silicone oil. Other silicone oils, for example dimethicone, hexamethylcyclotrisiloxane, phenyldimethicone, cyclomethicone (e.g. decamethylcyclopentasiloxane), hexamethylcyclotrisiloxane, polydimethylsiloxane, poly(methylphenylsiloxane), cetyidimethicone, behenoxydimethicone can also be used as oil or fat phase (d). Also advantageous are mixtures of cyclomethicone and isotridecyl isononanoate, and those of cyclomethicone and 2-ethylhexyl isostearate.

In one embodiment of the present invention, silicone oils which may be chosen are those silicone compounds whose organic side chains are derivatized, for example polyethoxylated and/or polypropoxylated. These include, for example, polysiloxane polyalkyl-polyether copolymers, such as, for example, cetyl dimethicone copolyol. Cyclomethicone (octamethylcyclotetrasiloxane) is advantageously used as a specific silicone oil.

In one embodiment of the present invention, the oil or fat phase (d) can be chosen from the group of vegetable waxes, animal waxes, mineral waxes and petrochemical waxes. For example candelilla wax, carnauba wax, Japan wax, esparto grass wax, cork wax, guaruma wax, rice germ oil wax, sugarcane wax, berry wax, ouricury wax, montan wax, jojoba wax, shea butter, beeswax, shellac wax, spermaceti, lanolin (wool wax), uropygial grease, ceresine, ozokerite (earth wax), paraffin waxes and microwaxes are advantageous.

In one embodiment of the present invention, the oil or fat phase (d) can be chosen from chemically modified waxes and synthetic waxes, for example Syncrowax®HRC (glyceryl tribehenate) and Syncrowax®AW 1 C(C₁₈-C₃₆-fatty acid), montan ester waxes, sasol waxes, hydrogenated jojoba waxes, synthetic or modified beeswaxes (e.g. dimethicone copolyol beeswax and/or C₃₀-C₅₀-alkyl beeswax), cetyl ricinoleates, polyalkylene waxes, in particular polyethylene waxes, polyethylene glycol waxes, chemically modified fats, such as, for example, hydrogenated plant oils, for example hydrogenated castor oil and/or hydrogenated coconut fatty glycerides), hydrogenated triglycerides, such as, for example, hydrogenated soy glyceride, trihydroxystearin, fatty acids, fatty acid esters and glycol esters, such as, for example, C₂₀-C₄₀-alkyl stearate, C₂₀-C₄₀-alkylhydroxy stearoylstearate and/or glycol montanate. Certain organosilicon compounds which have similar physical properties to the specified fat and/or wax components, such as, for example, stearoxytrimethylsilane, are also advantageous.

In one embodiment of the present invention, the oil or fat phase (d) can be chosen from the group of phospholipids. Phospholipids are phosphoric esters of acylated glycerols. Of greatest importance among the phosphatidylcholines are, for example, the lecithins, which can be described by the general structure

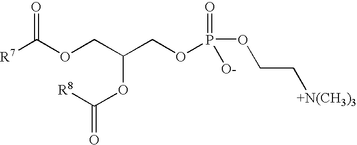

where R⁷ and R⁸ may be identical or different and are chosen from unbranched aliphatic or olefinic radicals having 15 or 17 carbon atoms and represent up to 4 cis-double bonds.

Mixtures according to the invention can also comprise one or more fragrances or aroma substances (e).

Suitable fragrances may pure substances or mixtures of natural or synthetic volatile compounds which develop an odor. Natural fragrances are extracts from flowers (lily, lavender, rose, jasmine, neroli, ylang-ylang), stems and leaves (geranium, patchouli, petit grain), fruits (anis, coriander, caraway, juniper), fruit peels (bergamot, lemon, orange), roots (mace, angelica, celery, cardamom, costus, iris, calmus), woods (pinewood, sandalwood, guaiac wood, cedar wood, rosewood), herbs and grasses (tarragon, lemongrass, sage, thyme), needles and branches (spruce, fir, pine, dwarf-pine), resins and balsams (galbanum, elemi, benzoin, myrrh, olibanum, opoponax). Also suitable are animal raw materials, such as, for example, civet and castoreum. Typical synthetic fragrances are products of the ester, ether, aldehyde, ketone, alcohol and hydrocarbon type. Fragrances of the ester type are, for example, benzyl acetate, phenoxyethyl isobutyrate, 4-tert-butyl cyclohexylacetate, linalyl acetate, dimethylbenzylcarbinyl acetate, phenylethyl acetate, linalyl benzoate, benzyl formate, ethylmethyl phenylglycinate, allyl cyclohexylpropionate, styrallyl propionate and benzyl salicylate. Fragrances of the ether type include, for example, benzyl ethyl ether, the fragrances of the aldehyde type include, for example, linear alkanals having 8 to 18 carbon atoms, citral, citronellal, citronellyloxyacetaldehyde, cyclamenaldehyde, hydroxycitronellal, lilial and bourgeonal, the fragrances of the ketone type include, for example, ionones, α-isomethylione and methyl cedryl ketone, the fragrances of the alcohol type include, for example, anethol, citronellol, eugenol, isoeugenol, geraniol, linalool, benzyl alcohol, phenylethyl alcohol and terioneol, and the fragrances of the hydrocarbon type include primarily the terpenes and balsams. However, preference is given to using mixtures of different fragrances which together produce a pleasing scent note. Essential oils of lower volatility, which are mostly used as aroma components, are also suitable as fragrances, e.g. sage oil, chamomile oil, oil of cloves, Melissa oil, mint oil, cinnamon leaf oil, linden blossom oil, juniper berry oil, vetiver oil, olibanum oil, galbanum oil, labolanum oil and lavandin oil. Preference is given to using bergamot oil, dihydromyrcenol, lilial, lyral, citronellol, phenylethyl alcohol, α-hexylcinnamaldehyde, α-amylcinnamaldehyde, geraniol, benzyl acetone, cyclamenaldehyde, linalool, Boisambrene®Forte, ambroxan, indole, hedione, sandelice, lemon oil, mandarin oil, orange oil, allyl amyl glycolate, cyclovertal, lavandin oil, clary sage oil, α-damascone, geranium oil bourbon, cyclohexyl salicylate, evernyl, iraldein gamma, phenylacetic acid, geranyl acetate, benzyl acetate, rose oxide, romillat, irotyl and floramat, alone or in mixtures.

Mixtures according to the invention can also comprise one or more additives (f). Additives (f) can be chosen from conditioning agents, antioxidants, ethoxylated glycerol mono- or difatty acid esters, thickeners, foam foamers, wetting agents and humectants, biocides, organic solvents, such as, for example, ethanol or isopropanol, glitter substances and/or other effect substances (e.g. color streaks). Glitter substances and other effect substances (e.g. color streaks) are essentially of esthetic importance.

Examples of conditioning agents are listed in the International Cosmetic Ingredient Dictionary and Handbook (Volume 4, editor: R. C. Pepe, J. A. Wenninger, G. N. McEwen, The Cosmetic, Toiletry, and Fragrance Association, 9th edition, 2002) under Section 4 under the keywords Hair Conditioning Agents, Humectants, Skin-Conditioning Agents, Skin-Conditioning Agents-Emollient, Skin-Conditioning Agents-Humectant, Skin-Conditioning Agents-Miscellaneous, Skin-Conditioning Agents-Occlusive and Skin Protectants. Further examples of conditioning agents are compounds listed in EP-A 0 934 956 (p. 11 to 13) under “water soluble conditioning agent” and “oil soluble conditioning agent”. Further advantageous conditioning agents are, for example, the compounds referred to in accordance with INCI as Polyquaternium (in particular Polyquaternium-1 to Polyquaternium-56). A very particularly preferred conditioning agent is N,N-dimethyl-N-2-propenyl-2-propeneaminium chloride (Polyquaternium-7).

Further examples of advantageous conditioning agents are cellulose derivatives and quaternized guar gum derivatives, in particular guar hydroxypropylammonium chloride (e.g. Jaguar Excel®, Jaguar C 162® (Rhodia), CAS 65497-29-2, CAS 39421-75-5).

Nonionic poly-N-vinylpyrrolidone/polyvinyl acetate copolymers (e.g. Luviskol®VA 64 (BASF)), anionic acrylate copolymers (e.g. Luviflex®Soft (BASF)), and/or amphoteric amide/acrylate/methacrylate copolymers (e.g. Amphomer® (National Starch)) can also be used advantageously according to the invention as conditioners. Further examples of advantageous conditioning agents are quaternized silicones.

Examples of ethoxylated glycerol mono- or difatty acid esters are PEG-10 olive oil glycerides, PEG-11 avocado oil glycerides, PEG-11 cocoa butter glycerides, PEG-13 sunflower oil glycerides, PEG-15 glyceryl isostearate, PEG-9 coconut fatty acid glycerides, PEG-54 hydrogenated castor oil, PEG-7 hydrogenated castor oil, PEG-60 hydrogenated castor oil, jojoba oil ethoxylate (PEG-26 jojoba fatty acids, PEG-26 jojoba alcohol), glycereth-5 cocoate, PEG-9 coconut fatty acid glycerides, PEG-7 glyceryl cocoate, PEG-45 palm kernel oil glycerides, PEG-35 castor oil, olive oil PEG-7 ester, PEG-6 caprylic/capric glycerides, PEG-10 olive oil glycerides, PEG-13 sunflower oil glycerides, PEG-7 hydrogenated castor oil, hydrogenated palm kernel oil glyceride PEG-6 ester, PEG-20 corn oil glycerides, PEG-18 glyceryl oleate cocoate, PEG-40 hydrogenated castor oil, PEG-40 castor oil, PEG-60 hydrogenated castor oil, PEG-60 corn oil glycerides, PEG-54 hydrogenated castor oil, PEG-45 palm kernel oil glycerides, PEG-80 glyceryl cocoate, PEG-60 almond oil glycerides, PEG-60 evening primrose glycerides, PEG-200 hydrogenated glyceryl palmatate, PEG-90 glyceryl isostearate.

Preferred ethoxylated glycerol mono- or difatty acid esters are PEG-7 glyceryl cocoate, PEG-9 cocoglycerides, PEG-40 hydrogenated castor oil, PEG-200 hydrogenated glyceryl palmatate.

Ethoxylated glycerol mono- or difatty acid esters are used in mixtures according to the invention for different purposes. Ethoxylated glycerol mono- or difatty acid esters having 3 to 12 ethylene oxide units per molecule serve as refatting agents for improving the feel on the skin after drying, ethoxylated glycerol mono- or difatty acid esters having 30 to 50 ethylene oxide units per molecule serve as solubility promoters for nonpolar substances such as fragrances. Ethoxylated glycerol mono- or difatty acid esters with more than 50 ethylene oxide units per molecule are used as thickeners. Examples of suitable antioxidants are all antioxidants which are customary or suitable for cosmetic and/or dermatological applications.

Preferably, antioxidants are chosen from the group of amino acids (e.g. glycine, histidine, tyrosine, tryptophan), imidazoles (e.g. urocanic acid), peptides, such as D,L-carnosine, D-carnosine, L-carnosine and derivatives thereof (e.g. anserine), carotenoids, carotenes (e.g. α-carotene, β-carotene, γ-lycopene), chlorogenic acid and derivatives thereof, lipoic acid and derivatives thereof (e.g. dihydrolipoic acid), aurothioglucose, propylthiouracil and other thiols (e.g. thioredoxin, glutathione, cysteine, cystine, cystamine and the glycosyl, N-acetyl, methyl, ethyl, propyl, amyl, butyl and lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low doses (e.g. pmol to μmol/kg of mixture according to the invention), also (metal) chelating agents (e.g. α-hydroxy fatty acids, palmitic acid, phytic acid, lactoferrin), α-hydroxy acids (e.g. citric acid, lactic acid, maleic acid), humic acid, bile acid, bile extracts, bilirubin, biliverdin, EDTA, EGTA, unsaturated fatty acids (e.g. γ-linolenic acid, linoleic acid, oleic acid), folic acid, furfurylidenesorbitol, ubiquinone and ubiquinonol vitamin C and derivatives (e.g. ascorbyl palmitate, Mg ascorbyl phosphate, ascorbyl acetate), tocopherols and derivatives (e.g. vitamin E acetate), vitamin A and derivatives (vitamin A palmitate), and coniferyl benzoate of benzoin resin, rutinic acid and derivatives thereof, α-glycosylrutin, ferulic acid, furfurylideneglucitol, carnosine, butylhydroxytoluene, butylhydroxyanisole, nordihydroguaiacic acid, nordihydroguaiaretic acid, trihydroxybutyrophenone, uric acid and derivatives thereof, mannose and derivatives thereof, zinc and derivatives thereof, (e.g. ZnO, ZnSO₄), selenium and derivatives thereof (e.g. selenomethionine), stilbenes and derivatives thereof (e.g. stilbene oxide, in particular trans-stilbene oxide) and suitable derivatives (salts, esters, ethers, sugars, nucleotides, nucleosides, peptides and lipids).

Suitable thickeners for mixtures according to the invention are crosslinked polyacrylic acids and derivatives thereof, carrageen, xanthan, polysaccharides, such as xanthan gum, guar guar, agar agar, alginates or tyloses, cellulose derivatives, e.g. carboxymethylcellulose, hydroxycarboxymethylcellulose, hydroxyethylpropylcellulose, hydroxybutylmethylcellulose, hydroxypropylmethylcellulose, also higher molecular weight polyethylene glycol mono- and diesters of fatty acids, fatty alcohols, monoglycerides and fatty acids, polyvinyl alcohol and polyvinylpyrrolidone.

Suitable thickeners are also, for example, hydrophilic fumed silica gels, polyacrylamides, polyvinyl alcohol and polyvinylpyrrolidone, esters of fatty acids with polyols, such as, for example, pentaerythritol or trimethylolpropane, fatty alcohol ethoxylates with a narrow homolog distribution or C₁-C₂₀-alkyl oligoglucosides, and electrolytes, such as sodium chloride and ammonium chloride.

Biocides suitable for mixtures according to the invention are agents with a specific effect against Gram-positive bacteria, e.g. triclosan (2,4,4′-trichloro-2′-hydroxydiphenyl ether), chlorhexidine (1,1′-hexamethylenebis[5-(4-chlorophenyl)biguanide), and TTC (3,4,4′-trichlorocarbanilide). Highly suitable biocides are also isothioxalones, such as, for example, 5-chloro-2-methyl-3(2H)isothiazolone and 2-methyl-3(2H)isothiazolone. Quaternary ammonium compounds are in principle likewise suitable and are preferably used for disinfecting soaps and washing lotions. Numerous fragrances also have biocidal properties. A large number of essential oils or their characteristic ingredients, such as, for example, oil of cloves (eugenol), mint oil (menthol) or thyme oil (thymol), also exhibit marked antimicrobial effectiveness. Further suitable biocides are fluorine compounds, which are suitable, for example, for caries prophylaxis, such as, for example, NaF, amine fluorides.

Examples of foam formers may, for example, be surfactants (c) referred to above, in particular sodium lauryl sulfate.

Numerous abovementioned surfactants (c) also act as wetting agents, particularly preferred examples of wetting agents are alkylbenzenesulfonates of the formula R⁹—C₆H₄—SO₃M′, where M¹ is as defined above and R⁹ is a C₈-C₁₂-alkyl radical. Preferred alkylbenzenesulfonates are so-called LAS (linear alkylbenzenesulfonates) which have been prepared using linear C₈-C₁₂-paraffins.

Examples of humectants are sorbitol, glycerol, polyethylene glycol, for example with a molecular weight Mₙ in the range from 200 to 1000 g/mol.

Mixtures according to the invention can also comprise colorants, for example dyes or pigments, glitter substances and/or other effect substances (e.g. color streaks).

In one embodiment of the present invention, mixtures according to the invention comprise:

0.1 to 10% by weight, preferably 1 to 5% by weight, of pieces of aminoplastic foam (a),
a total of 1 to 99.8% by weight, preferably 10 to 85% by weight, of surfactant (c),
0 to 20% by weight, preferably 1 to 15% by weight of oil or fat phase (d),
0 to 10% by weight, preferably 0.1 to 5% by weight of fragrance or aroma substance (e),
a total of 0 to 5% by weight, preferably 1 to 4% by weight, of additives (f),
where the data in % by weight are based on the total mixture according to the invention, the remainder is preferably water (b).

In one embodiment, mixtures according to the invention can comprise one or more antioxidants in the range from a total of 0.001 to 3% by weight, particularly preferably 0.05 to 2% by weight, in particular 0.1 to 1% by weight. If vitamin E and/or derivatives thereof are the antioxidant or the antioxidants, a content in the range from 0.001 to 1% by weight is preferred. If vitamin A or vitamin A derivatives or carotenes are the antioxidant or the antioxidants in mixtures according to the invention, content in the range from 0.001 to 1% by weight is preferred.

In one embodiment of the present invention, mixtures according to the invention may comprise biocide in the range from 0.1 to 0.3% by weight.

In one embodiment of the present invention, mixtures according to the invention have a pH in the range from 2 to 12, preferably 3 to 10 and particularly preferably 5 to 9. Here, it is preferred if those mixtures which are intended to be used for washing the body have a pH in the range from 2 to 12, preferably 4 to 9, particularly preferably 5 to 8.

In one embodiment of the present invention, mixtures according to the invention have a dynamic viscosity at 23° C. in the range from 100 to 100 000 mPa·s. Dynamic viscosities can be determined, for example, using a Brookfield viscometer.

Mixtures according to the invention can naturally comprise one or more abrasives known per se, for example silica gel, silicate, pumice, marble, polyethylene, apricot shell, superabsorbents. However, it is preferred if mixtures according to the invention comprise no further abrasives.

Mixtures according to the invention are exceptionally suitable for washing the body and for cleaning surfaces of all types. In the case of the use of mixtures according to the invention for washing the body, for example when washing hands heavily smeared with oil, it is firstly observed that the parts of the body in question easily become clean even without great application of force. Secondly, it can be observed that the skin is protected, the skin reddening often observed when using strong abrasives is not observed or is only observed to a very greatly reduced degree.

Mixtures according to the invention can, for example, be used as or for the preparation of cleaners, bath and shower gels, peels, toothpastes, handwashing pastes. Examples of cleaners are all-purpose cleaners, spray cleaners, concentrates for cleaners, window and glass cleaners, windscreen cleaners, car shampoos, oven cleaners, liquid synthetic soap, floor cleaners, such as, for example, soap cleaners and disinfectant floor cleaners, imitation leather cleaners, plastic cleaners, scouring compositions, such as, for example, liquid scouring compositions and scouring powders, carpet cleaners, such as, for example, foam cleaners for carpets and spray extraction cleaners, washing pastes for, for example, textiles.

Mixtures according to the invention can, for example, have the appearance of a slightly viscous or highly viscous liquid, a paste, a cleansing milk, a gel or a soap, e.g. a hand soap.

The present invention thus further provides the use of mixtures according to the invention as cleaners. The present invention further provides a method of cleaning surfaces using mixtures according to the invention.

In this connection, surfaces are as defined in the introduction.

In a particularly preferred variant of the present invention, surfaces are those made of shiny material, for example enamel, glass, metals such as, for example, stainless steel, plastics, in particular shiny plastics, ceramics such as, for example, tiles, or porcelain.

To carry out the method according to the invention, the starting point is soiled surfaces, which may be evenly or unevenly soiled to a greater or lesser degree.

Soilings to be removed may, for example, be:

fats, oils, waxes, for example polyethylene waxes, paraffin waxes, paraffin oils, ester oils, natural oils and fats, lubricating greases, bearing greases, Stauffer greases, montan waxes,
metal salts of anionic surfactants, such as, for example, lime soap, biofilms, for example mold or pseudomonas biofilms,
polymers, for example paint gun, polyurethane foam, silicones (polysiloxanes),
metal oxides, for example copper oxide, lead oxide or nickel oxide or rust produced by, for example, corrosion, or rust particles or aircraft rust, in particular iron oxides,
metal hydroxides and metal carbonates, which may be neutral, acidic or basic, in particular iron hydroxide, copper hydroxide, nickel hydroxide, aluminum hydroxide, magnesium hydroxide, MgCO₃, basic MgCO₃, CaCO₃, basic copper carbonate, where metal oxides, metal carbonates and metal hydroxides can be formed by corrosion from the base metal of the structured surface, for example a tool or material, or else can have been secondarily deposited,
residues of lubricants, for example partially carbonized or partially or completely resinified lubricants, and broken emulsions. Examples which may be mentioned are: resinified natural ester oils on, for example, chainsaws, or carbonized oils on hot plates used in spinning polyester filament fibers, also lubricating oils, for example, from the automotive sector, also from automobiles or bicycles,
deposits and cakings of, for example, cement or gypsum,
usual domestic soiling such as house dust, also mixed with fats, grease from the kitchen area, also in resinified form, for example roasting fat or frying oil.

Further examples of soilings to be removed are written markings, for example with ballpoint pen or felt-tip pen.

Soilings may be distributed evenly or unevenly on surfaces to be cleaned, for example in the form of spots, rings, splashes, or in the form of a film.

The period of time chosen for the method according to the invention may, for example, be periods in the range from a few seconds, for example 5 seconds, to 24 hours, preferably 1 minute to 3 hours and particularly preferably up to one hour.

To carry out the cleaning method according to the invention, the procedure may, involve, for example, applying mixture according to the invention in neat or in dilute form, in particular in form diluted with water, to the surface to be cleaned.

To carry out the cleaning method according to the invention, aids which may be used are one or more cloths, brushes or sponges.

The present invention further provides a method of producing mixtures according to the invention, also called production method according to the invention. The production method according to the invention can be carried out by mixing together, for example stirring,

(a) pieces of open-cell aminoplastic foam with an average diameter in the range from 50 μm to 5 mm (weight-average),
(b) water,
(c) at least one surfactant and
(d) if appropriate an oil or fat phase
in any order. If it is desired to produce paste-like mixtures according to the invention, then mixing is preferably carried out using a high-speed stirrer, particularly preferably at reduced pressure, for example at 20 to 100 mbar.

After carrying out the actual production process according to the invention, mixtures according to the invention can also be formulated, for example extruded or processed to give soap-like bars.

The invention is explained by working examples.

### I.1 Preparation of aminoplastic foam

In an open vessel, a spray-dried melamine/formaldehyde precondensate (molar ratio 1:3, molecular weight about 500 g/mol) was added to an aqueous solution with 3% by weight of formic acid and 1.5% of the sodium salt of a mixture of alkylsulfonates having 12 to 18 carbon atoms in the alkyl radical (emulsifier K 30 from Bayer AG), the percentages referring to the melamine/formaldehyde precondensate. The concentration of the melamine/formaldehyde precondensate, based on the total mixture of melamine/formaldehyde precondensate and water, was 74% by weight. The mixture obtainable in this way was stirred vigorously, then 20% by weight of n-pentane were added. The mixture was further stirred (for about 3 min) until a dispersion which looked homogeneous was formed. This dispersion was knife-coated onto a teflonized glass cloth as support and foamed and hardened in a drying cabinet where an air temperature of 150° C. prevailed. During this, the mass temperature within the foam which was established was the boiling temperature of the n-pentane, which is 37.0° C. under these conditions. After 7 to 8 min, the maximum rise height of the foam was achieved. The foam was left for a further 10 minutes in the drying cabinet at 150° C.; it was then heat-treated for 30 min at 180° C. This gave aminoplastic foam.

The following properties were ascertained on the aminoplastic foam:

99.6% open-cell according to DIN ISO 4590,
compressive strength (40%) 1.3 kPa determined according to DIN 53577,
density 7.6 kg/m³ determined according to EN ISO 845,
average pore diameter 210 μm, determined by analyzing micrographs on sections,

### BET surface area of 6.4 m²/g, determined according to DIN 66131,

sound absorption of 93%, determined according to DIN 52215,
sound absorption of more than 0.9, determined according to DIN 52212.

### I.2 Preparation of aminoplastic foam pieces (a.1) by grinding

A cuboid of aminoplastic foam according to 1.1 was ground using a fly-cutter-operated laboratory analysis mill (model A10) and then sieved through a shaking sieve of mesh width 250 μm. This gave pieces of open-cell aminoplastic foam (a.1) with an average diameter of up to 250 μm. The sieve residue was discarded.

### I.3 Preparation of mixtures according to the invention

### I.3.1 Preparation of a domestic cleaner, general procedure

The following were mixed together:

3 g of n-C₁₂H₂₅—SO₄Na (c.1)
0.5 g of Na stearate (c.2)
2 g of the ethoxylation product of oleylcetyl alcohol with 17 equivalents of ethylene oxide (c.3)
2 g of the ethoxylation product of n-C₁₈H₃₇—OH with 7 equivalents of ethylene oxide (c.4)
0.5 g of ethanol
0.2 g of a mixture of fragrances (e.1) to (e.5), comprising identical parts by weight of α-amylcinnamaldehyde, α-hexylcinnamaldehyde, 4-n-butylphenylmethylpropionaldehyde,
0.1 g of benzyl alcohol, linalool,
1 g of benzalkonium chloride (biocide, (f. 1))
and made up to 100 g with water (b).

This gave an abrasive-free cleaner V-R.5, which was placed in a 150 ml beaker. Pieces of open-cell aminoplastic foam (a.1) were then added according to Table 1 using a glass rod and stirred with the glass rod. This gave the mixtures according to the invention R.1 to R.4 according to Table 1, which are also referred to as cleaners R.1 to R.4 according to the invention. In each case, the settling behavior and the cleaning effect were tested.

### I.3.2 Preparation of a shower gel

Shower gel was prepared by mixing a so-called surfactant phase and a so-called water phase.

To prepare the surfactant phase, the following were mixed together:

3000 g of 28% by weight aqueous solution of n-C₁₂H₂₅—(OCH₂CH₂)₃—OSO₃—Na⁺
600 g of sodium cocamphoacetate
600 g of cocoamidopropylbetaine
770 g of 13% by weight aqueous solution of polyquaterium-44 [SHBN006]
300 g of sodium laureth sulfate
50 g of perfume oil (scent: apple-peach)
2000 g of distilled water.

This gave a surfactant phase.

To prepare the water phase, the following were mixed together:
100 g of D-panthenol (D-(+)-2,4-dihydroxy-N-(3-hydroxypropyl)-3,3-dimethylbutyramide
10 g of 3:1 mixture (parts by weight) of 5-chloro-2-methyl-3(2H)isothiazolone and 2-methyl-3(2H)isothiazolone
30 g of citric acid
100 g of sodium chloride
0.15 g of yellow-orange 85 E 110
2440 g of distilled water.

This gave a water phase.

To prepare an abrasive-free shower gel, the following were mixed together: 73.7 g of surfactant phase (see above) and 26.7 g of water phase. This gave shower gel V-DG.5.

To prepare shower gels according to the invention, 100 g of abrasive-free shower gel V-DG.1 were initially introduced. Pieces of open-cell aminoplastic foam (a.1) were then added in accordance with Table 2 using a glass rod and stirred using the glass rod. This gave the mixtures DG.1 to DG.4 according to the invention in accordance with Table 2, which are also referred to as shower gels DG.1 to DG.4 according to the invention. In each case, the settling behavior and the cleaning effect were tested.

### II. Cleaning of surfaces

### II.1 Cleaning of surfaces using domestic cleaners according to Example I.3.1

To test the cleaning effect, a stainless steel covered in limescale sink was used. In each case, a couple of drops of neat cleaner according to 1.3.1 were applied to a damp cloth and the lime was rubbed. The cleaning effect was then assessed visually.

TABLE 1
Composition and cleaning effect of cleaners according to the
invention and comparison cleaners

| | Additive (a.1) | | Assessment of the |
|---|---|---|---|
| Cleaner | [g] | Settling behavior | cleaning effect |
| R.1 | 1 | Settles immediately | Good, no scratches |
| R.2 | 2 | Settles immediately | Good, no scratches |
| R.3 | 5 | Settles immediately | Good, no scratches |
| R.4 | 10 | Settles immediately | Good, no scratches |
| V-R.5 | — | — | Satisfactory, no scratches |
| V-R.6 | — | Settles immediately | Good, but sink scratched |

V-R.5 was abrasive-free cleaner according to Example I.3.1 without the addition of an abrasive.
V-R.6 corresponded to V-R.5 to which 2 g of pumice powder had also been added as abrasive.

### II.2 Cleaning of hands soiled with lubricating oil (bicycle chain)

Both hands were soiled with lubricating oil (bicycle chain). The hands were wetted with water. Several drops of one of the shower gels according to the invention or of one of the comparison shower gels according to Table 2 were then put into the hand and the hands were rubbed. The hands were rinsed briefly with hand-warm water and dried with a hand towel and the cleaning effect was assessed visually.

TABLE 2
Composition and cleaning effect of shower gels according to
the invention and comparison shower gels

| | Additive | | |
|---|---|---|---|
| Shower | (a.1) | | Assessment of the cleaning |
| gel | [g] | Settling behavior | effect |
| DG.1 | 1 | Settles immediately | Good, no skin reddening |
| DG.2 | 2 | Settles immediately | Good, no skin reddening |
| DG.3 | 5 | Settles immediately | Good, no skin reddening |
| DG.4 | 10 | Settles immediately | Good, no skin reddening |
| V-DG.5 | — | — | Moderate, no skin reddening |
| V-R.6 | — | Settles immediately | Good, but skin reddening |

V-DG.5 was abrasive-free cleaner according to Example I.3.2 without the addition of an abrasive.
V-DG.6 corresponded to V-DG.5 to which 2 g of polyethylene had also been added as abrasive.

1. A mixture comprising
(a) pieces of open-cell aminoplastic foam with an average diameter in the range from 50 μm to 5 mm (weight-average),
(b) water,
(c) at least one surfactant and
(d) if appropriate an oil or fat phase.

2. The mixture according to claim 1, wherein surfactant (c) is chosen from nontoxic surfactants.

3. The mixture according to claim 1, wherein the mixture has a dynamic viscosity in the range from 100 to 100 000 mPa·s at 23° C.

4. The mixture according to claim 1, wherein pieces of open-cell aminoplastic foam (a) are prepared from aminoplastic foam with a density in the range from 5 to 500 kg/m³ and an average pore diameter in the range from 1 μm to 1 mm by mechanical comminution.

5. The mixture according to claim 1, wherein said mixture additionally comprises up to 10% by weight of at least one fragrance or aroma substance (e).

6. A method of cleaning surfaces using a surface comprising applying to the surface at least one mixture according to claim 1 as a cleaner.

7. The method according to claim 6, wherein the surface comprises a shiny material.

8. A cleaner or shower gel comprising the mixture according to claim 1.

9. A method of producing the mixture according to claim 1, wherein said method comprises mixing together the following
(a) pieces of open-cell aminoplastic foam with an average diameter in the range from 50 μm to 5 mm (weight-average),
(b) water,
(c) at least one surfactant and
(d) if appropriate an oil or fat phase.

10. The method according to claim 9, wherein said mixing is carried out in a plurality of stages.
